(19) United States
(12) Patent Application Publication
(10) Pub. No.: US 2011/0137939 A1
(43) Pub. Date: Jun. 9, 2011

(54) Data Supervision Based on the Configuration Rule of All Operational Indicators

(75) Inventors: YIMIN ZHAO, Nanjing (CN); JIE LI, Nanjing (CN); XIAOHUA CHAO, Nanjing (CN); XIAOJUN SHEN, Nanjing (CN); XUEZHI ZHANG, Nanjing (CN); HAIDONG PANG, Nanjing (CN)

(73) Assignee: LINKAGE TECHNOLOGY GROUP CO., LTD., Nanjing (CN)

(21) Appl. No.: 12/962,550

(22) Filed: Dec. 7, 2010

(30) Foreign Application Priority Data
Dec. 9, 2009 (CN) 200910232396.1

(51) Int. Cl. G06F 17/30

(52) U.S. Cl. 707/769; 707/E17.014

(57) ABSTRACT

Using the way of destruct, the complex system is split into several different qualitative elements (the definition of indicator, the definition of database, the definition of scheduling, the definition of check way, etc.). Each element has its special concept. Combing different elements organically, a completely certain meaning indicator-checked incident is produced, and it is possible to finish the expected indicator-checked task flexibly. In the case of the check fails, due to the pre-warning it is possible to perform the manual intervention in time.

### CROSS REFERENCE TO RELATED PATENT APPLICATION

The present application claims the priority of the Chinese patent application No. 200910232396.1 filed on Dec. 9, 2009, which application is incorporated herein by reference.

### FIELD OF THE INVENTION

This invention involves in a method that monitors data quality based on the configuration rule of indicators. It is especially used by Telecom operators for finding the accuracy of KPI, OLAP, report forms in Business Analyse & Support System (BASS), important KPI indicators in primary Business Analyse & Support System, etc.

### BACKGROUND OF THE INVENTION

Telecom operators have to control large quantities of the operational indicator under BASS in order to find and solve the problems in time and to ensure the correctness of the data.

The general steps are described as: firstly, the telecom operators propose the relative data and the monitoring indicators, and then, the manufactories verify the caliber, develop, test and go-life. Therefore, the whole process is not only complicated but also has long design cycle. In addition, due to the increase of the monitoring indicators, if the indicators can't be generated during the required time, it is possible to influence the report of data, the evaluation of province companies and to increase the task of the developers.

Using this mode, it is difficult to satisfy the monitoring of some emergent indicators. At the same time, with the increase of the requirement, the ratio of the monitoring indicators in BASS becomes higher and higher, and the duration of producing the output data of the system is greatly influenced.

In this traditional mode, it is not possible to reach the requirement of operators on the monitoring of the quality data in time and of the pre-warning system. Since the system construction becomes more and more complicated, the points of Data Supervision increases continuously, it becomes more important to know how to master the system's operation state in time.

### SUMMARY OF THE INVENTION

This invention aims at proposing a method of Data Supervision based on the configuration rule of all operational indicators. It is realized by using an easily understood and a more flexible configure method to configure the system conveniently, by monitoring the indicators data quality, by being scheduled by scheduler and by generating the check result.

This invention is designed by the thesis of the component. By classifying concepts, for example, the definition of indicators, the definition of database, the definition of checked rules, the definition of scheduling way, etc. and then by generating the configuration of monitoring collection point, the configuration of check way, the configuration of scheduling way, it is possible to generate a integrate concept of the checking indicators. Finally, it is realized to implement the proper indicators checked at right time and in right way, then to get the final result which is in accordance with the checked rules.

The detail design process is introduced as follows:
a) The definition of indicators: to acquire the source through locating an interested indicator using the method of SQL.
b) The definition of database: to define the visited information of database.
c) The definition of scheduling: to define several scheduling methods such as timing, toggle condition.
d) Select the way of checking: to select the suitable indicator checkout way according to the actual acquirement. If the checkout scope of the values is just for a signal indicator, it is possible to select “value examinations”, otherwise, if an indicator is required to be compared with that in history at same period, it is possible to select “polygraph examinations”, etc. In addition, there also exist other ways of checking indicators, for example, relevance examinations, equilibrium examinations, cross examinations, unbelievable examinations, and so on.
e) Configure checked parameters: to select the suitable definition of indicators from definition library which have already defined in the past (An integrated SELECT sentence, through this sentence, it is possible to acquire the indicator information which users care for, such as the income of a city at a special time, the number of the users, or the number of the users off-grid), the definition of database (including the detail visit information of the database such as service name, user name, password, etc.), the definition of scheduling way (scheduling timing or condition scheduling). Then to configure suitable checked parameter, to locate border values which satisfy indicators or not (in the case of the value examination, it is necessary to locate suitable go-life realm value, otherwise, in the case of polygraph examinations, it is necessary to formulate comparative cycle, and to locate polygraph value, etc.), or to calculate formula (In the case of equilibrium regulation, it is necessary to define the regular express such as A+B=C).
f) Submit to scheduler for running and for the checked result. (scheduler will run in view of configure information, and will generate the check report)

Due to the flexibility of the indicator definition, it only requires operator to configure a simple SQL statement, and then to define the running way of this indicator. Once the condition is satisfied, the system will run checking automatically, will show the running result on stage interface, and will send message to the operator to solve problem in time in the case that there exist indicators which exceed the located clique value. Therefore, it is possible to avoid its influence on the following data.

Data Supervision based on the configuration rule of all operational indicators, aims just at relieving the workload of the developers, at reducing the influence on the system performance, and also at avoiding cumbersome procedures. Its main feature lays in:
1. Comprehensive monitoring scope, all indicators acquired by SQL can be included into the monitoring scope.
2. Monitoring flexibly, operating easily.
3. Getting rid of the dependency on the database, economic on investment, convenient for transporting.
4. Reducing the influence on BASS.

### BRIEF DESCRIPTION OF THE INVENTION

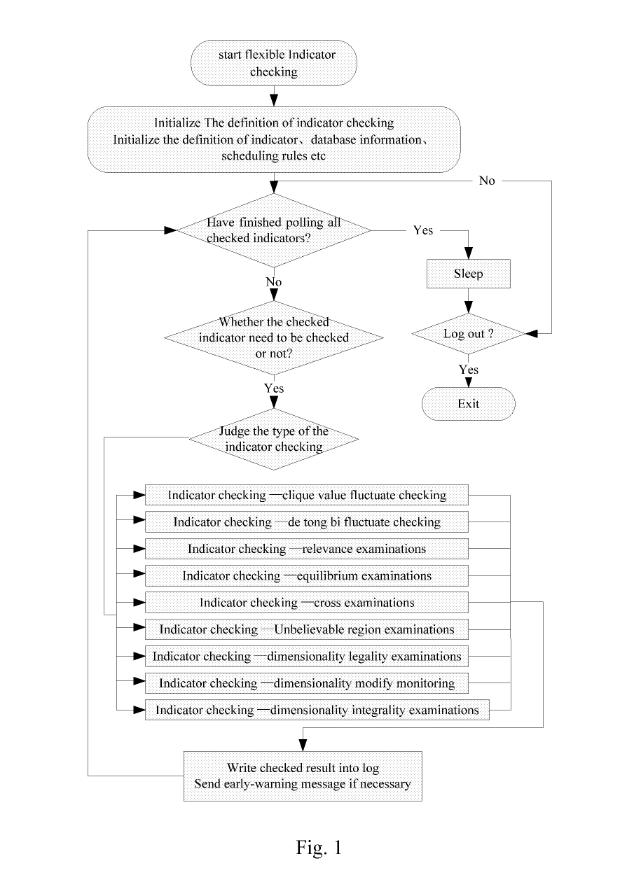

FIG. 1 is the designing flowchart of this invention.

### DETAIL DESCRIPTION OF THE INVENTION

Combined with the following chart and example, elaborate this invention further

This invention uses the design clues of object oriented, packages several major elements into several main classes, respectively, such as: indicator defining classes (includes the unique code of the definition of indicator, indicator type, the attribute of, SQL statement produced by indicator. In the case of the practical scheduling, using the unique code to judge current indicator type and to run the SQL statements), scheduling way classes (includes schedule way unique code, schedule type, schedule days list, schedule date list and the attribute of schedule condition list. Scheduler is identified by scheduling way unique code), database classes (by directing at every main database, include oracle, sybase, DB2, NCR, etc. and by generating the common visited interfaces), flexible monitored indicators classes (to embody above mentioned classes, to make special checking way, to configure detail border parameter or formula and to produce a complete certain meaning indicator-checked incident).

The designation of several key objected classes:
SmartKpiCheck classes: includes the definition of indicator list, database list, indicator checked list, which define the list of defining indicator, the list of database information, the list of checking indicator, respectively. All these information are saved in an internal memory, and the information used for scheduling is obtained from this class.
Indicators defining classes: includes the unique code of the definition of indicator, indicator type, the attribute of SQL statement produced by indicator. Once the real scheduling come true, it judges current indicator type and the SQL statements to be carried out by unique code.
Scheduling way classes: includes schedule way unique code, schedule type, schedule days list, schedule date list, the attribute of schedule condition list. Scheduler is identified by schedule way unique code.
Data Supervision is based on the configuration rule of all operational indicators, and is designed by the thesis of component. This technology is a configurable application module which exists in application platform independently. The integer application should be monitored by the way of defining indicator's SQL, and should select scheduling timing or scheduling rely on condition according to practical requirement.

What is claimed is:

1. Data supervision method based on the configuration rule of all operational indicators comprising:
by defining indicators, database, checking rules, scheduling ways to KPI, OLAP, report forms in Business Analyse & Support System (BASS) and important KPI indicators in primary Business Analyse & Support System, it provides the configuration of monitoring collection points, configuration of checking way, configuration of scheduling way of every data indicators in Business Analyse & Support System (BASS), generates an integrate indicators checking, implements special indicator checking at special time and finally obtains the results of whether fit for the checking rules or not;
the definition of indicator: to appoint an indicator to be monitored and to acquire data using the way of SQL;
the definition of database: to define the visited information of database;
the definition of scheduling: to define several scheduling ways such as timing and toggle condition;
select checkout type: according to actual acquirement, to select suitable indicator checkout way. If checkout scope of the values just for signal indicator, it is possible to select “value examinations”, otherwise, if an indicator need to be compared with that in history at same period, it is possible to select “polygraph examinations”;
configure checkout parameters: to select suitable definition of indicators, the definition of database, the definition of scheduling way from definition library which have already been defined in the past. To configure suitable checked parameter, to locate border values for the satisfaction of the indicators or computing formula;
then, it is submitted to scheduler for running and for the checked result;
if there exists indicators which exceed the located clique value, a message should be sent to the require-men in time in order to solve problem in time and to avoid the influence to later data.

2. The data supervision method based on the configuration rule of all operational indicators of claim 1, wherein the indicators defining classes, which includes the unique code of the definition of indicator, indicator type, the attribute of SQL statement produced by indicator, judge current indicator type and the SQL statements to be run by unique code, once real scheduling come true; the scheduling way classes includes schedule way unique code, schedule type, schedule days list, schedule date list and the attribute of schedule condition list; scheduler is identified by schedule way unique code, and the content of database classes as follows: to direct at every main database which includes oracle, Sybase, DB2 and NCR, etc., to generate common visited interfaces, flexible monitored indicators classes, to embody above item classes, by making special checking way, to configure detail border parameter or formula and to produce a completely certain meaning indicator-checked incident; using system decomposition method to break up a complex system as some factors with different character, i.e. target definition, data base definition, deployment definition, examination definition, each factor expresses special concept, through combining different factors to form a target examination event with complete content, complete prospective target examination task; if the examination is not passed, intervene by manual work can be processed in time through early warning mode.
